(19) United States
(12) Patent Application Publication
(10) Pub. No.: US 2002/0138793 A1
(43) Pub. Date: Sep. 26, 2002

(54) Iterative decoding of differentially modulated symbols

(76) Inventor: Leif Wilhelmsson, Dalby (SE)

Correspondence Address: Richard J. Moura, Jenkens & Gilchrist, P.C., Suite 3200, 1445 Ross Avenue, Dallas, TX, 75202-2799, US

(21) Appl. No.: 09/818,307

(22) Filed: Mar. 26, 2001

(51) Int. Cl. G06F 11/00

(52) U.S. Cl. 714/701

(57) ABSTRACT

Method and apparatus for decoding block-coded data which has been transmitted by means of differential modulation. The method first attempts to decode all codewords using an error correcting code, and if at least one codeword is still not decoded, uses a correctly decoded codeword to locate a possibly erroneous code symbol in the at least one codeword, alters the possibly erroneous code symbol, and again attempts to decode the at least one codeword. The invention recognizes that errors in such data typically occur in pairs, and utilizes this property to improve the decoding process.

### BACKGROUND OF THE INVENTION

1. Field of the Invention

The present invention relates generally to the field of digital communications; and, more particularly, to a method and apparatus for decoding block-coded data which has been transmitted by means of differential modulation.

2. Description of the Prior Art

Differential modulation, such as differential phase shift keying (DPSK), is used in digital communications systems to avoid the need for an absolute phase reference. Because differential modulation is probably most commonly used in connection with PSK, the following description is made assuming that DPSK is the modulation. As will become apparent, however, differential modulation is also applicable to modulation formats other than PSK; and it should be clearly understood, that it is not intended to limit the invention to DPSK

To further facilitate the following description, it is additionally assumed that the modulation is binary although it is also not intended to limit the invention in this regard. As will be discussed hereinafter, the present invention can be readily extended to larger alphabets.

For a binary transmission, a sequence to be transmitted (which may possibly be encoded for error correction)

c=c₀, c₁, c₂,

is differentially encoded according to

sᵢ=cᵢ⊕sᵢ₋₁, (1)

where we define s₋₁=0, and where ⊕ denotes modulo-2 addition.

The symbol, sᵢ, is then, for instance, modulated and transmitted according to the rule

s(t)=Acos(2πƒ_{c}+s_{iπ}),iTₛ [symbol] t≦(i+1)Tₛ, (2)

where Tₛ is the symbol duration time. We will refer to the combination of (1) and (2) above, i.e., the differential encoding and the actual modulation, as differential modulation.

At the receiver side, the reverse operation is performed in order to extract the (possibly coded) sequence. More precisely, first the symbol s₁ is demodulated and then it follows from (1) that the symbol c₁ is obtained as

cᵢ=sᵢ⊕sᵢ₋₁. (3)

From (3), it can be easily seen that sᵢ will affect both cᵢ and Cᵢ₊₁. Therefore, if sᵢ is in error, this will typically result in that both c₁ and Cᵢ₊₁ are in error. For an uncoded transmission, i.e., where the symbols c₁ are information symbols, this has the effect that the error probability is doubled compared to the case where a perfect reference phase is available.

In the case of binary block coding, where k information bits are encoded into n coded bits, the degradation is much worse. For instance, assume that an error correcting block code which is able to correct one error is employed. This code would effectively be useless since a codeword will either be received without any errors, so that no error correction is needed; or the codeword will contain at least two errors, which cannot be corrected by the code in any event.

Also, in the case when a more powerful random error correcting code is employed, the performance will be heavily degraded because of the bursty nature of the errors.

In order to improve the performance of the error correcting code, it is known that interleaving can be employed. To explain the working procedure of an interleaver, reference is made to FIG. 1, which schematically illustrates an apparatus for encoding and decoding digital data transmitted over a communication channel; and FIG. 2, which schematically illustrates the structure of an interleaver.

First, with reference to FIG. 1, at the transmitter side, generally designated by reference number 10, the k information bits (DATA IN) are encoded into n symbols by encoder 12, which symbols constitute one codeword; and the n symbols are written row-wise into interleaver 14. This is indicated by the “In” arrow in FIG. 2. When all the m rows are filled, the coded symbols, Cᵢ, are read out column-wise, as indicated by the “Out” arrow in FIG. 2, and then modulated according to (1) by modulator 16. The modulated signal is then transmitted over a communication channel 18.

At the receiver side, generally designated by reference number 30, the reverse operation is performed. That is, first the received symbol sᵢ is demodulated by demodulator 20 and the symbols cᵢ are obtained. Then, these symbols are written into a deinterleaver 22; and, from the deinterleaver, the symbols cᵢ are decoded by decoder 24 to provide output data (DATA OUT).

The symbols cᵢ are written into the deinterleaver 22 column-wise. In this way the error-pairs will appear column-wise in the deinterleaver, since the differential modulation was performed on the symbols column-wise. This also means that the error correcting code will work better, since the errors in each row will appear to be independent of one another (although the errors in the different codewords are not).

The reason for using an interleaver/deinterleaver is that the communication channel over which the data is transmitted is typically changing in such a way that many consecutive received symbols can be unreliable, thus preventing an error correction code from working properly. This is illustrated in FIG. 1 by the noise component 26 introduced into the communication channel 18.

For the error correction code to work properly with an interleaver, the interleaving depth, m, should be at least as large as the number of consecutive unreliable symbols that can be received. For differential encoding, the situation is generally similar but also somewhat different. Assuming that the quality of the channel is not changing, there will no longer be a number of consecutive unreliable symbols; but, instead, there will be two symbols that are in error (not just unreliable). Clearly, then, it will suffice to let the interleaving depth m=2 in order break up the burst.

Although the above described procedure, which is well known in the art, does improve the performance for a coded system, the procedure is far from optimal in the case of differential encoding. Specifically, although it is known that the errors appear in pairs, as indicated above, with differential encoding; this knowledge is not used in the above procedure.

### SUMMARY OF THE INVENTION

The present invention provides a method and apparatus for decoding block-coded data in a digital communications system wherein the block-coded data is transmitted by differential modulation.

A method according to the present invention comprises the steps of:

a. attempting to decode all transmitted codewords;

b. if at least one codeword is still not decoded, using a correctly decoded codeword to locate at least one possibly erroneous code symbol in the at least one codeword that is still not decoded;

c. altering the at least one possibly erroneous code symbol; and

d. again attempting to decode the at least one codeword that is still not decoded.

The present invention recognizes that when block-coded digital data is transmitted by means of differential modulation, errors in the transmitted codewords are not independent but typically appear in pairs; and utilizes this property to improve the decoding process.

According to a presently preferred embodiment of the invention, an interleaver is used to improve the performance of an error correcting code. In particular, at the receiver side, the error correcting code is used to attempt to decode all the transmitted codewords; which are arranged in a sequential manner, for example, in a row-wise manner, in the deinterleaver. The using step comprises using a correctly decoded codeword that either immediately precedes or immediately succeeds a codeword that is still not decoded to locate the possibly erroneous code symbol in the codeword that is still not decoded. More specifically, if the immediately preceding codeword or the immediately succeeding codeword contains an erroneous code symbol at a particular location, but the next preceding or the next succeeding codeword has also been correctly decoded and does not contain an erroneous code symbol at a corresponding location, then it is very likely that the codeword that is still not decoded does contain an erroneous code symbol at the corresponding location (since the errors typically appear in pairs) Accordingly, the likely erroneous code symbol is altered and it is again attempted to decode the codeword that is still not decoded.

According to a presently preferred embodiment of the invention, as code symbols in codewords which are not correctly decoded are altered, and as those altered codewords are correctly decoded, the method is repeated again and again in an iterative manner until all codewords are correctly decoded or until there are no more symbols that can be altered according to the method.

In general, with the present invention a significantly decreased error probability is provided with only a slight increase in computational complexity. If the invention is used, for example, in combination with an ARQ scheme, it results in that fewer retransmissions are necessary, thus increasing the throughput. Also, it should be noted that since the first step in the procedure of the present invention may be identical to the standard procedure currently followed, and since the iterative procedure according to the present invention can be stopped at any time, even if it is not finished, with the result being at least as good as the standard procedure; it offers a great deal of flexibility for many applications.

Yet further advantages and specific details of the present invention will become apparent hereinafter in conjunction with the following detailed description of presently preferred embodiments.

### BRIEF DESCRIPTION OF THE DRAWINGS

FIG. 1 schematically illustrates a system for encoding and decoding digital data transmitted over a communication channel;

FIG. 2 schematically illustrates the structure of the interleaver of FIG. 1;

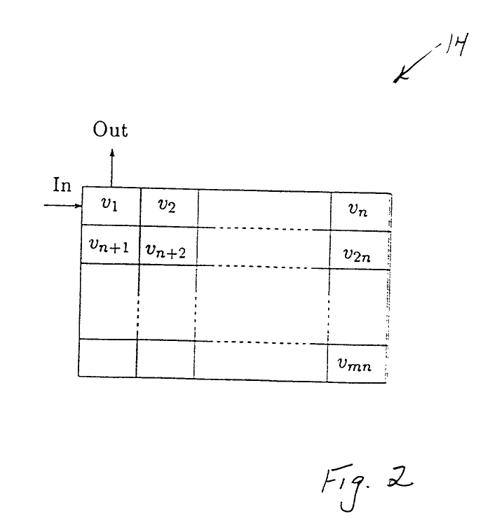

FIGS. 3 through 5 schematically illustrate steps of the decoding procedure according to a presently preferred embodiment of the present invention;

FIG. 6 is a flow chart illustrating a method for decoding an interleaved data block according to a presently preferred embodiment of the invention; and

FIGS. 7 and 8 are IQ-diagrams provided to assist in explaining alternative embodiments of the invention.

### DETAILED DESCRIPTION OF PRESENTLY PREFERRED EMBODIMENTS

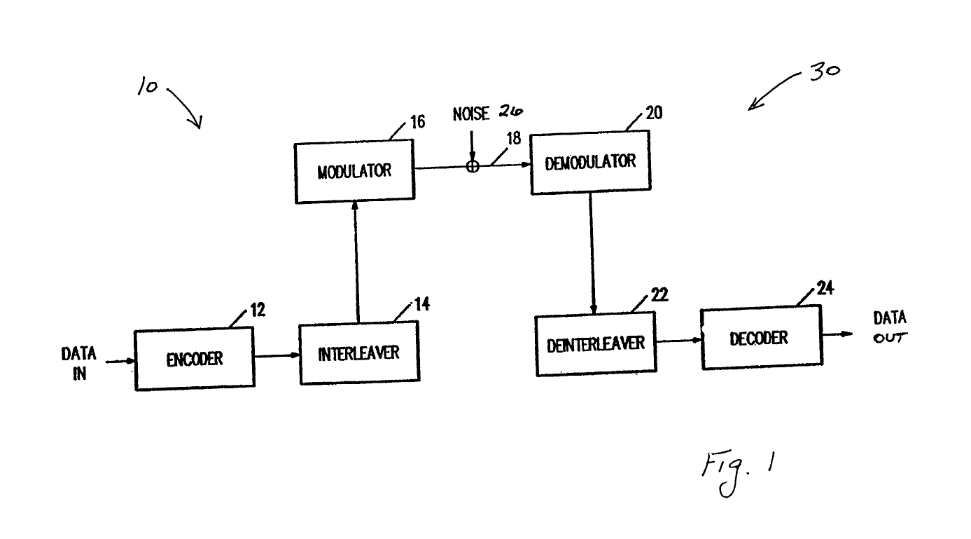

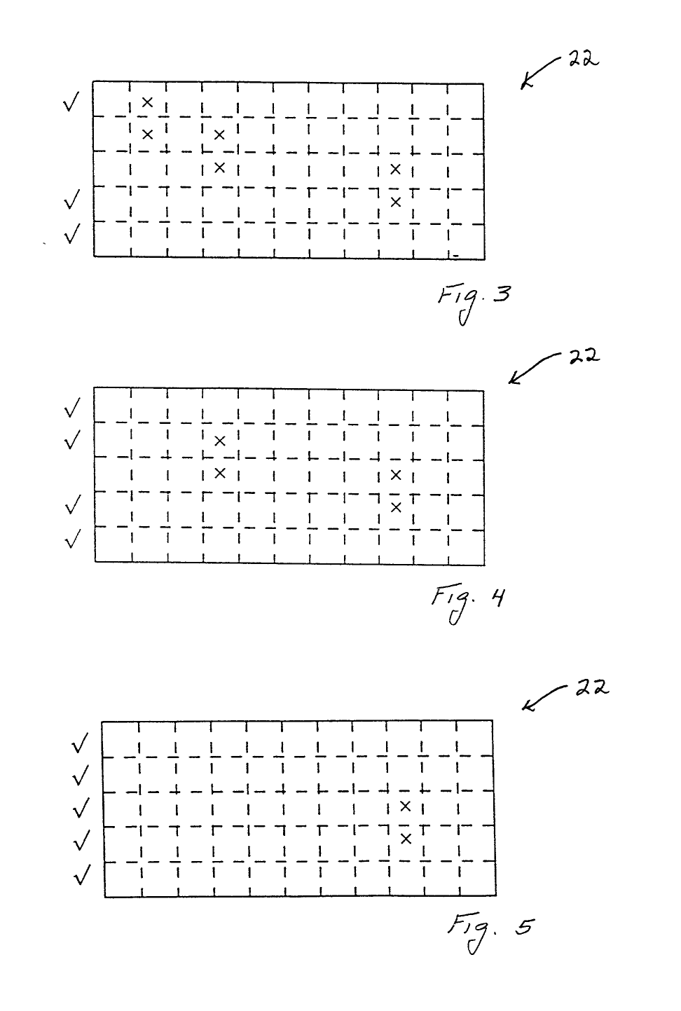

FIGS. 3-5 schematically illustrate the structure of a deinterleaver, such as the deinterleaver 22 of FIG. 1, to assist in explaining the present invention. As mentioned previously, the present invention relates to the decoding of block-coded data that has been transmitted by means of differential modulation such as DPSK; and it is assumed in the following discussion that the modulation is binary, although generalization to a larger alphabet will be made hereinafter.

Initially, in accordance with the present invention, an attempt is made to decode the m codewords in the deinterleaver in the usual manner, i.e., by using a random error correcting code. If this attempt is successful, the decoding process is completed. Now, assume that the number of rows in the deinterleaver is five (m=5); and, further, assume that all the errors are located as depicted in FIG. 3. (In FIGS. 3-5, the locations of the erroneous code symbols or bits in the deinterleaver are indicated by “X”, whereas the “✓” symbol indicates codewords that can be correctly decoded using the error correcting code.) Furthermore, assume that the employed error correcting code is capable of correcting only single errors but that it is also able to detect if two errors have occurred.

Clearly, then, because the codewords corresponding to the second and the third rows in FIG. 3 contain two errors; they cannot be correctly decoded by the error correcting code. In the situation where only the standard decoding procedure is used, accordingly, those codewords would be declared to be in error and would either have to be accepted as erroneous or a retransmission would be requested. If the retransmission scheme is able to ask for retransmission of a single codeword, this would be done; otherwise, a retransmission of the data for the entire interleaver would be requested.

On the other hand, by using the decoding procedure of the present invention, the two codewords declared to be in error can easily be corrected. The procedure is as follows:

First, with reference again to FIG. 3, consider the two preceding rows in the interleaver (note that since the interleaver is filled up column-wise, this means that the last codeword in the interleaver will “precede” the first codeword). Since the first codeword and the last codeword were correctly decoded, it is known which (if any) symbols in these codewords were received in error. In this particular case, it is known that the second symbol in the first codeword in the deinterleaver was received in error and that the last codeword in the deinterleaver did not contain any errors at all. As a consequence, assuming that the errors appear pair-wise due to the fact that differential modulation is used, it is known that the second symbol in the second codeword is also erroneous. Therefore, this bit as well as the bit that was found erroneous in the first codeword are changed. After this is done, the erroneous bits in the deinterleaver will be located as shown in FIG. 4. Since one of the bits in the second codeword has changed, it makes sense to try to decode that codeword once again. Since that codeword now only contains one error, the decoding will be successful. Consequently, only the third codeword is still not decoded.

However, repeating the same procedure that was used for the second codeword, it is noted, in FIG. 4, that the fourth symbol in the second codeword is in error whereas the fourth symbol in the first codeword is not. Again, since the errors are assumed to occur in pairs, we therefore change the fourth symbol in both the second and third codewords, so that the erroneous bits in the deinterleaver now are located as depicted in FIG. 5. Again, since one of the symbols in the third codeword has been changed, we try to decode this codeword once again. Since the codeword now contains only one error, the decoding will be successful.

Thus, we have successfully corrected the codewords in both the second row and the third row, even though those codewords contained two errors and even though the error correcting code that was employed was only able to correct one error.

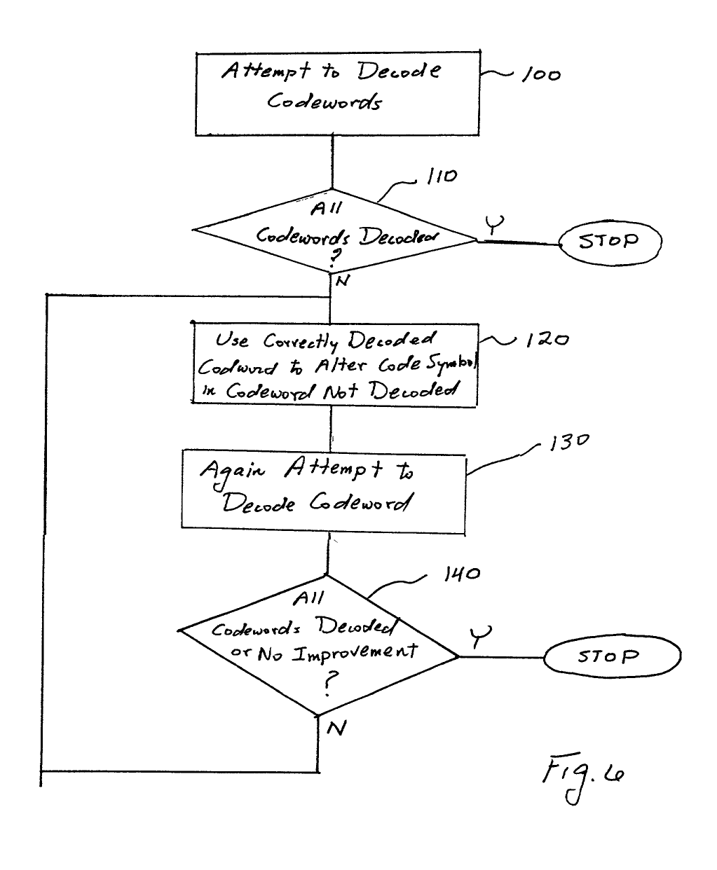

In the case of binary modulation, a decoding procedure according to a presently preferred embodiment of the invention can be generally described as follows, with reference to the flow chart of FIG. 6:

1. Initially, attempt to decode all m codewords in the deinterleaver using a random error correcting code (Step 100). If all the codewords are correctly decoded (Y output of Step 110) , STOP. If not, (N output of Step 110), continue.

2. For a codeword still not decoded, check if the two preceding codewords (or the two succeeding codewords) in the deinterleaver are correctly decoded. If so, find all positions where the very preceding (or the very succeeding) codeword has a code symbol error but the other codeword of the two has not, and alter the code symbol at the corresponding position in the codeword still not decoded (Step 120).

3. Again attempt to decode the altered codeword using the error correcting code (Step 130). If all the codewords are now correctly decoded, or if there are no more code symbols that can be altered (Y output of Step 140), STOP, otherwise continue (N output of Step 140).

4. For those codewords not still decoded, again check if the two preceding codewords (or the two succeeding codewords) are correctly decoded. If so, find all positions where the very preceding (or very succeeding) codeword has a code symbol error but the other of the two has not and alter the symbol at the corresponding location in the codeword still not decoded, and try again to decode all codewords still not decoded but in which at least one of the code symbols has been altered since the last time it was tried to decode the codeword (repeat steps 120 and 130 until all codewords are corrected or no further improvement is made).

It should be understood, as indicated above, that the rows in the deinterleaver should be thought of as a circular list, so that when the next codeword is referred to and the codeword is the last one, the next codeword that is being referred to is actually the first one in the deinterleaver. Moreover, when these kinds of “wrap-around” effects happen, it should be noticed that symbol j in the last codeword in the deinterleaver is succeeded by symbol j+1 in the first row. However, all these things are easily realized by considering how the data is written into the deinterleaver, namely column-wise.

As should be apparent from the above, with the present invention, it often becomes possible to correctly decode codewords that would otherwise not be correctable by standard decoding procedures in that the codewords contain more errors than are otherwise correctable. The present invention makes use of the fact that in differential modulation, errors appear in pairs so as to further improve the ability to correct errors in codewords that would not otherwise be correctable.

As indicated previously, the above description assumes that the modulation is binary. In the case of M-ary modulation, the algorithm has to be modified accordingly.

In the case that the code used is also M-ary, the algorithm will have to be slightly modified in that not only the position probable to be in error has to be found, but also the actual error value. To see how this can be easily accomplished, consider the situation with an arbitrary choice for M and wherein DPSK is used. In this case, the transmitted symbols are given by

s(t)=Acos(2πƒ_{c}+s₁2*π/M),iTₛ [symbol] t≦(i+1)Tₛ, (4)

where sᵢε{0,1, . . . M−1}. Furthermore, the differential modulation is then performed according to

sᵢ=cᵢ+sᵢ₋₁modM . (5)

That is, signal sᵢ is created as the sum of the previously sent signal sᵢ₋₁ and the actual information c₁ modulo M. As can be readily seen, for M=2, this expression is identical with equation (1).

At the receiver side, c₁ is obtained by considering the difference between sᵢ and sᵢ₋₁ modulo M, i.e.,

c₁=sᵢ−sᵢ₋₁ mod M (6)

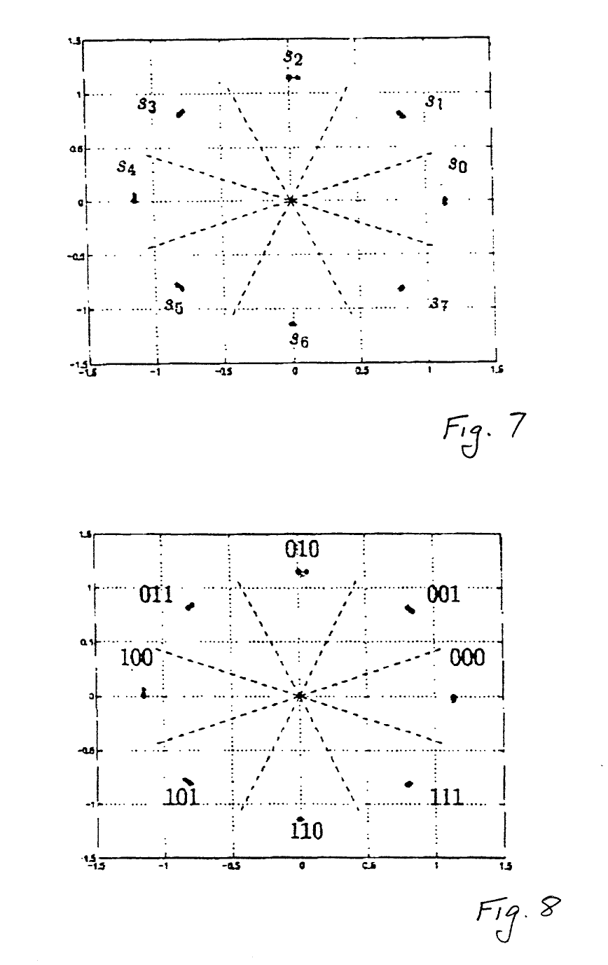

Again, for M=2, this is identical to equation (3). Now, referring to equation (6), it is easily seen how the error value is found. If one knows that c₁₋₂ was correct and that c₁₋₁ was erroneous, and that the error was 1, it is readily seen that not only will cᵢ be erroneous, but also that the error will be −1. Clearly, the two errors are due to the fact that the symbol s₁₋₁ has been decoded to the correct value plus one. This can also be seen in FIG. 7, which is an example of what the IQ-diagram might look like where the different signal points are shown in the case M=8. An error of +1 means that the correct symbol is m, whereas the decoded symbol is m+1 (modulo M) . FIG. 7 also shows the reason why the error is typically ±1. The most likely errors are those where a decision is made in favor of a neighboring point rather than to the correct one. For instance, if sₒ is the correct symbol, it is highly unlikely that the error is such that one decides in favor of s₄. Rather, the typical errors given that sₒ is transmitted would be that either s₁ or s₇ is received.

In the case of M-ary modulation, M=₂^{j}, j being an integer, and a binary code; one will have to determine what bits are in error for a specific symbol error. Since the mapping from bits to symbols is known this will present no problem. Once the possibly erroneous bits have been determined, these are changed; and, again, decoding of the corresponding codewords takes place. The difference in the binary case is only that although the erroneous M-ary symbols are next to each other due to the differential modulation, the erroneous bits do not have to be consecutive. This is illustrated in FIG. 8, which illustrates an example of what the IQ-diagram might look like for M=8 with binary representation.

Again, suppose that one has found that cᵢ and c₁₋₁ are in error and that, in fact sᵢ₋₁=2=s₁₋₁+1 where s₁₋₁=1.

Using the exact same arguments as for the case of M-ary coding, this implies that ĉᵢ=c₁−1 and ĉᵢ₋₁=cᵢ₋₁+1. Now suppose that cᵢ₋₁=1 and c₁=5,and consequently ĉ₁₋₁=2 and ĉᵢ=4, referring to FIG. 8 it is readily seen that this means that the correct binary stream corresponding to c₁₋₁ and cᵢ equals “001101” has been erroneously decoded as “010100”. Clearly the bit errors are not adjacent. However, since the mapping from M-ary symbols to bits are known this is easily taken into consideration in the iterative decoding process.

In general, the present invention provides, at the cost of only slightly greater computational complexity, a decreased error probability. In the case that the invention is used in combination with an ARQ scheme, it results in that fewer retransmissions are necessary thus increasing the throughput. It should also be noted that since the first step of the algorithm in the present invention is identical to the standard procedure, and since the iterative procedure could be stopped at any time, even before it is finished, with a result being at least as good as the standard procedure; the present invention provides great flexibility which more than compensates for the slightly increased computational complexity.

It should be emphasized that the term “comprises/comprising” when used in this specification is taken to specify the presence of stated features, integers, steps or components, but does not preclude the presence or addition of one or more other features, integers, steps, components or groups thereof.

It should also be emphasized that while what has been described herein constitutes presently most preferred embodiments of the invention, it should be recognized that the invention could take numerous other forms. Accordingly, it is to be understood that the invention should be limited only insofar as is required by the scope of the following claims.

1. In a digital communications system wherein information is coded into blocks and transmitted by differential modulation, and wherein an interleaver is employed to improve performance of an error correcting code, a method for decoding the block-coded data which includes steps of:
attempting to decode all codewords in a deinterleaver using an error correcting code;
if at least one codeword is still not decoded, check to see if either the two preceding codewords or the two succeeding codewords in the deinterleaver are correctly decoded;
if one of the two preceding codewords or the two succeeding codewords are correctly decoded, find a position where the just preceding codeword or the just succeeding codeword has a code symbol error but the other codeword does not have a code symbol error;
alter a symbol at a corresponding position in the codeword still not decoded; and
again attempting to decode all codewords still not decoded.

2. The method according to claim 1, wherein said step of again attempting to decode all codewords still not decoded comprises again attempting to decode all codewords still not decoded and in which at least one code symbol has been altered since the last time it was attempted to decode the codeword.

3. The method according to claim 2, wherein the steps are repeated until either all codewords are correctly decoded or there are no more symbols that can be altered.

4. The method according to claim 2, wherein the method can be stopped at any time, even if all codewords have not been correctly decoded and even if further symbols can be altered.

5. The method according to claim 1, wherein said differential modulation comprises differential phase shift keying (DPSK).

6. The method according to claim 1, wherein said differential modulation comprises M-ary modulation, and wherein said error correcting code is binary.

7. The method according to claim 1, wherein both said differential modulation and said error correcting code are M-ary.

8. The method according to claim 7, wherein M=2.

9. A digital communications system comprising:
a. transmitting side for transmitting differentially modulated block-coded and interleaved data over a communication channel; and
b. a receiving side for receiving the transmitted data, the receiving side including a demodulator for demodulating the differentially modulated data, a deinterleaver for deinterleaving the interleaved data, and a decoder f or decoding the data, the decoder including an error correcting code for attempting to decode all codewords in the deinterleaver, and, if at least one codeword is still not decoded, for altering a possibly erroneous code symbol in the at least one codeword that is still not decoded using a correctly decoded codeword in the deinterleaver to identify said possibly erroneous code symbol, and again attempting to decode the at least one codeword still not decoded.

10. The system according to claim 9, wherein said decoder uses a correctly decoded codeword that contains at least one erroneous code symbol at a location to identify said possibly erroneous code symbol at a corresponding location in a codeword still not decoded.

11. The system according to claim 10, wherein said decoder uses a correctly decoded codeword either just preceding or just succeeding the codeword still not decoded in the deinterleaver.

12. The system according to claim 11, wherein said decoder uses a correctly decoded codeword either just preceding or just succeeding the codeword still not decoded when the next preceding or the next succeeding codeword in the deinterleaver is also correctly decoded but does not contain a code symbol error at a location corresponding to the location at which the just preceding codeword or the just succeeding codeword contains a code symbol error.
